(19) United States
(12) Patent Application Publication
(10) Pub. No.: US 2002/0059521 A1
(43) Pub. Date: May 16, 2002

(54) Method and system for identifying a user

(75) Inventor: Martin Tasler, Erlangen (DE)

Correspondence Address: YOUNG & THOMPSON, 745 SOUTH 23RD STREET 2ND FLOOR, ARLINGTON, VA, 22202

(73) Assignee: Siemens Aktiengesellschaft

(21) Appl. No.: 09/978,026

(22) Filed: Oct. 17, 2001

(30) Foreign Application Priority Data
Oct. 17, 2000 (DE) 10051461.8

(51) Int. Cl. H04L 9/32

(52) U.S. Cl. 713/186; 713/200

(57) ABSTRACT

Method and system for identifying a user A method for identifying a user, in which at least one person-specific feature of the user is requested by a central server and is transmitted to the central server by an input appliance of a user computer device via a telecommunication link, in particular over the Internet, and is compared with stored user data, the at least one person-specific feature being selected by the central server on the basis of the random principle from a plurality of features recorded in a first feature group comprising the print from at least one finger and/or the image of the iris of at least one eye and/or a voice sample and/or a sample signature and/or an image of at least part of the user and/or the genetic fingerprint and in a second feature group comprising the user name and/or the date of birth and/or a user number and/or a secret number.

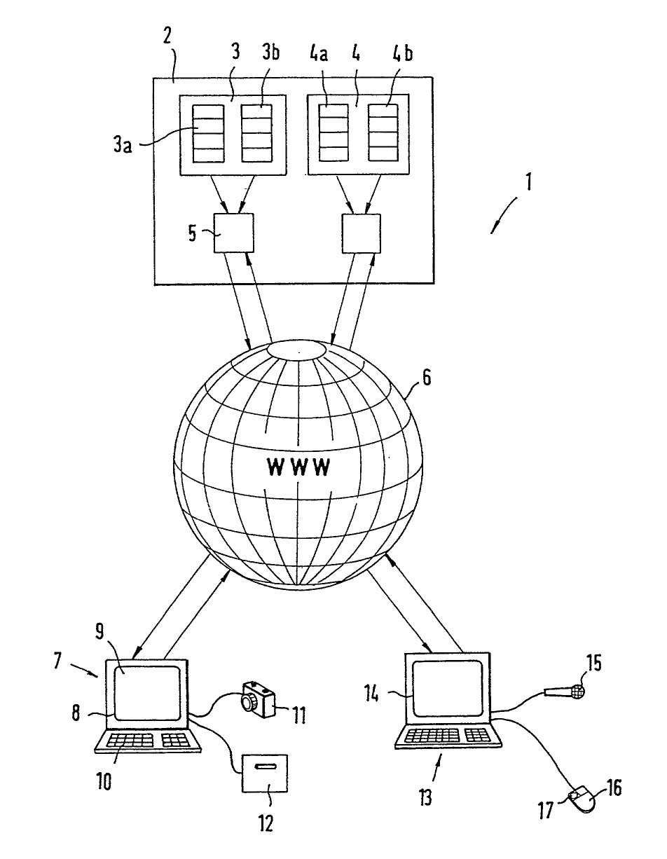

The invention relates to a method for identifying a user.

Identification methods for users are known in which a secret number or a password is requested over the Internet, for example, and is transmitted to a central server by the user. These data are compared with data stored on the server. In the event of a match, a payment operation, for example, can be enabled or the identification method is used to give the identified user access to a particular protected area on the Internet. The large and, in recent years, continually growing number of such systems means that a user needs to learn an increasing number of secret numbers, PIN numbers or passwords by heart. If these data are written down by the user, then there is a great risk of misuse if these written notes are lost or stolen, because the central server computer is not able to establish whether the user is the authorized holder of the access data.

To prevent such problems, identification methods are also known in which a personal feature, in particular a feature specific to a user's body, is checked. Common methods are those, in particular, which create an image of the iris of the human eye and those in which a fingerprint is used as an identification feature. In the same way, it has been proposed that handwriting be used as an identification feature, by virtue of a user submitting a sample signature. A common feature of all these methods is that the respective feature specific to the body needs to be recorded once by an authorized station and digitized, and is then stored in a database. This database usually contains further user-specific data records which, according to the purpose of use, may be the name, address or a customer number of the user, for example. A typical area of application for such identification methods is access control in buildings. In this case, the checked feature specific to the body is respectively evaluated in situ by a computer device which permits access if appropriate.

EP 0 895 750 A2 discloses an appliance which is used for identifying a user and which has a memory device storing person-specific features specific to the body, such as fingerprints, voice patterns, handprints or an image of the retina. From these features, one is selected at random for which the person wanting to work on the appliance has to provide evidence, with an appropriate sensor device, e.g. for recording a fingerprint, being provided for this purpose.

The invention is therefore based on the problem of specifying an identification method which is secure against corruption and can, in particular, also be used for Internet transactions.

This problem is solved by providing a method for identifying a user, in which at least one person-specific feature of the user is requested by a central server and is transmitted to the central server by an input appliance of a user computer device via a telecommunication link, in particular over the Internet, and is compared with stored user data, the at least one person-specific feature being selected by the central server on the basis of the random principle from a plurality of features recorded in a first feature group comprising the print from at least one finger and/or the image of the iris of at least one eye and/or a voice sample and/or a sample signature and/or an image of at least part of the user and/or the genetic fingerprint and in a second feature group comprising the user name and/or the date of birth and/or a user number and/or a secret number.

A combination of a plurality of features considerably increases security against corruption because the user cannot anticipate which feature(s) will be requested and checked by the central server. In this context, it is particularly advantageous that the user need learn neither secret numbers nor transaction numbers by heart and does not need to carry them with him. The identification preferably uses features specific to the body, which are inevitably borne by the user. Accordingly, the inventive identification method can be carried out at virtually any location at which a suitable input appliance is available. Even if the user is completely unprepared and is not carrying any of the otherwise necessary papers, such as a check card, he can perform a transaction.

The inventive method for identifying a user can be used for various types of transactions. Primarily suitable are orders and purchases over the Internet where payment can be authorized using the inventive method. In the same way, the user can gain access to personal information; by way of example, he can retrieve his account statements and can use the inventive method to authorize himself to do so.

To reduce the risk of misuse, provision may be made for a plurality of person-specific features to be selected and requested on the basis of the random principle. By way of example, provision may be made for the iris of one eye to be recorded and checked, while at the same time a fingerprint from the same user is checked. Only if both features match is the appropriate action, for example a purchase, processed.

Particularly secure and reliable identification methods are those in which the print from at least one finger or the image of the iris of one eye are used as features. In the same way, a voice sample from the user or a sample signature can be used as a checking feature, because these are specific to the respective person. Similarly, a camera can be used to record part of the body or part of the body profile and to compare it with previously stored data. Methods are also being tested in which the “genetic fingerprint” is used as an identification feature. In this context, noninvasive methods which do not harm the user are particularly preferred. These features specific to the body are stored in a first feature group.

It is expedient for a second feature group to be used to store further person-specific features, such as the user name, the address, the date of birth, the user or customer number, or a secret number. The server can also select and request at least one feature from this second feature group in the same way.

In the inventive method, preferably, at least one feature is chosen from the first feature group, containing features specific to the body, which afford a particularly high level of security.

In one development of the invention, the data are transmitted in encrypted form. Primarily, it is useful to encrypt the data with the person-specific feature which have been ascertained by the input appliance so that they cannot be read and used by unauthorized third parties.

The inventive identification method can likewise be used to create an electronic signature for an electronic message, so that the recipient of this message can be absolutely certain that the message actually originates from the indicated sender.

The invention also relates to a system for identifying a user having at least one central server having a database containing person-specific features for users, having at least one external, user computer device which communicates with the server over the Internet and has at least one input appliance which can be used for the server to request at least one person-specific feature and for transmitting said feature to the server, the person-specific features of a user being stored on the server in a person-specific data record containing a first feature group comprising the print from at least one finger and/or the image of the iris of at least one eye and/or an voice sample and/or a sample signature and/or an image of at least part of the user and/or the genetic fingerprint and containing a second feature group comprising the user name and/or the date of birth and/or a user number and/or a secret number, and the at least one person-specific feature requested being able to be selected on the basis of the random principle from the features in both feature groups.

One component of the inventive identification system may be a conventional personal computer used as the user computer device. This has at least one input appliance connected to it, which may be a digital camera or a microphone, for example. The input appliances convert the pictures and sounds into digital data, which the computer then transmits to the central server over the Internet. Alternatively or in addition, an input appliance for recording a fingerprint or a means for recording a sample signature may also be provided. In one development of the invention, the user computer device has an input appliance for recording and evaluating the genetic fingerprint of the user. It is also possible for a plurality of different input appliances to be connected to a particular user computer. Similarly, the input appliances can be combined with conventional input appliances, such as a magnetic card reader and a numerical or alphabetic keyboard.

Preferred identification systems are those which have a plurality of central servers having identical databases. This ensures a particularly high level of security against failure. In this case, it is important for the data records on the various servers to be regularly aligned, so that identical data records are stored on all the servers.

To prevent misuse, it is advantageous if the system comprises a means for data encryption and/or decryption. This means may be in the form of a software program, so that the data can be encrypted and decrypted automatically. This software may also be part of the software used for recording and digitizing the person-specific feature of the user.

The invention is explained in more detail below using a particularly suitable exemplary embodiment with reference to the FIGURE.

The FIGURE is a schematic illustration of the components of the inventive system for identifying a user. The system 1 comprises a central server 2, which is a computer system and has a database containing a multiplicity of user-specific data records 3, 4, two of which are shown by way of example. The first data record 3 contains a first feature group 3a containing person-specific features, including a fingerprint, an image of the outline of the head and a voice sample for the user. For the same user, a second feature group 3b stores further person-specific features, which are the name and address of the user and also bank account information.

The server 2 also contains a data record 4 with data for another user. The data in the data record 4 are likewise subdivided into the feature groups 4a and 4b.

The data records for the various users each have the same data structure; for new users, they are recorded once and are stored on the server 2.

To identify that user who has the associated data record 3, the central server 2 uses a software program to select at least one of the person-specific features from the first feature group 3a, and transmits the selected feature 5 via an Internet connection 6 to a user computer device 7 comprising a personal computer 8 with a screen 9 and an input keyboard 10. The personal computer 8 is connected to the Internet 6 in a known manner, for example using a modem (not shown). In the exemplary embodiment shown, the personal computer 8 has a digital camera 11 and a magnetic card reader 12 connected to it.

After the central server 2 has selected at least one feature 5 from the plurality of person-specific features in the feature group 3a, it sends a request asking for the selected feature 5 to the user computer device 7. The server 2 thus does not send the feature itself in digitized form, but rather the computer device 7 is asked to send the feature. On the screen 9, the user receives a request to provide evidence of a particular feature. As can be seen in the FIGURE, the user computer device 7 is designed to record picture data using the digital camera 11. The user can thus be asked to take an image of the contour of his head, which is then transmitted in digitized form from the digital camera 11 to the central server 2 over the

Internet 6 using the computer device 7. The central server uses the software program to check whether this feature is identical to the requested feature. In the event of a match, the central server 2 sends an acknowledgement to the computer device 7 via the Internet connection 6, so that the intended transaction, which may be a payment operation or an order, can be performed by the computer device 7. The respective feature requested is selected by a random number generator. Besides the at least one person-specific feature, the server 2 can also request a further feature from the first feature group 3a or from the second feature group 3b. In each case, however, at least one feature from the first feature group 3a is requested. The features in the second feature group 3b may, by way of example, be the user name, but may also be data stored on a card, for example on a magnetic or smart card. These data are read using the magnetic card reader 12 which is likewise connected to the computer device 7.

The central server 2 is connected to a multiplicity of external, user computer devices over the Internet. By way of example, the figure also shows a second computer device 13, which likewise comprises a personal computer 14. The personal computer 14 has a microphone 15 and an input appliance for recording fingerprints, a “fingerprint mouse”, connected to it. This fingerprint mouse 16 has a sensor element 17 which, when a finger is placed on it, records an image of the fingerprint and forwards this to the personal computer 14. To identify that user who has the associated data record 4, the server 2 transmits a request for at least one of the personal-specific features from the feature groups 4a and 4b to the computer device 13 via the Internet connection 6, and the computer device 13 records the feature in the manner described, digitizes it and transmits it to the server 2. For security purposes, all data transmitted via the Internet connection 6 are encrypted.

The individual user computer devices 7, 13 are entirely independent of one another and may be set up at a very great distance from one another. The respectively connected input appliances (digital camera 11, magnetic card reader 12, microphone 15, mouse 16) may be provided in different combinations.

1. A method for identifying a user, in which at least one person-specific feature of the user is requested by a central server and is transmitted to the central server by an input appliance of a user computer device via a telecommunication link, in particular over the Internet, and is compared with stored user data, the at least one person-specific feature being selected by the central server on the basis of the random principle from a plurality of features recorded in a first feature group comprising the print from at least one finger and/or the image of the iris of at least one eye and/or a voice sample and/or a sample signature and/or an image of at least part of the user and/or the genetic fingerprint and in a second feature group comprising the user name and/or the date of birth and/or a user number and/or a secret number.

2. The method as claimed in claim 1, characterized in that a plurality of person-specific features are selected and requested on the basis of the random principle.

3. The method as claimed in claim 2, characterized in that, in each case, at least one feature from the first feature group is chosen.

4. The method as claimed in one of the preceding claims, characterized in that the data are transmitted in encrypted form.

5. A system for identifying a user having at least one central server having a database containing person-specific features for users, having at least one external, user computer device which communicates with the server over the Internet and has at least one input appliance which can be used for the server to request at least one person-specific feature and for transmitting said feature to the server, the person-specific features of a user being stored on the server in a person-specific data record (3, 4) containing a first feature group comprising the print from at least one finger and/or the image of the iris of at least one eye and/or a voice sample and/or a sample signature and/or an image of at least part of the user and/or the genetic fingerprint and containing a second feature group comprising the user name and/or the date of birth and/or a user number and/or a secret number, and the at least one person-specific feature (5) requested being able to be selected on the basis of the random principle from the features in both feature groups (3a, 3b, 4a, 4b).

6. The system as claimed in claim 5, characterized in that the input appliance of the user computer device (7, 13) comprises at least one camera (11) and/or at least one microphone and/or at least one means (17) for recording a fingerprint.

7. The system as claimed in claim 5 or 6, characterized in that a plurality of central servers having identical databases are provided.

8. The system as claimed in one of claims 5 to 7, characterized in that the server (2) and/or the user computer device (7, 13) comprise a means for data encryption and decryption.
